(19) United States
(12) Patent Application Publication
(10) Pub. No.: US 2009/0213915 A1
(43) Pub. Date: Aug. 27, 2009

(54) Method for the non-bitrate-dependent encoding of digital signals on a bus system

(75) Inventor: Martin Wagner, Norderstedt (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: Koninklijke Philips Electronics N.V., Eindhoven (NL)

(21) Appl. No.: 11/631,213

(22) PCT Filed: Jun. 17, 2005
(86) PCT No.: PCT/IB05/51998

§ 371 Date: Feb. 25, 2009

(30) Foreign Application Priority Data
Jun. 30, 2004 (EP) 04103070.1

(51) Int. Cl. H04B 1/38

(52) U.S. Cl. 375/220

(57) ABSTRACT

To provide a bus system having a plurality of stations that are coupled together by an arrangement of lines and each have a transceiver and a control unit, a microcontroller, or the like, and to specify a method of encoding a digital message on a bus system in which method the digital message comprises at least one part that is encoded in a non-bitratedependent manner and by means of which method it becomes possible for a transceiver or a system base chip to independently receive and analyze the data transmitted on the bus line, and in particular, in accordance with the method, to individually wake a bus node by means of a given wake-up message even when the part of the bus node that is on standby at the relevant point in time does not have an accurate timer and also does not have any knowledge of the bitrate at which the data is transmitted on the bus, provision is made, under the bus system according to the invention, for at least one transceiver (100) to comprise means for the non-bitrate-dependent analysis of digital signals and, under the method according to the invention, for the value of a bit in that part of the message that is encoded in a non-bitratedependent manner to be represented by the lengths of successive dominant and recessive phases.

The invention relates to a bus system having a plurality of stations that are coupled together by an arrangement of lines and that each have a transceiver and a control unit, as defined in the preamble to claim 1, and to a method of encoding a digital message on a bus system in which the digital message comprises at least one part that is encoded in a non-bitrate-dependent manner, as defined in the preamble to claim 4. The invention also relates to a transceiver for use in a bus system having a plurality of stations, as defined in the preamble to claim 10.

It is known that, by exchanging suitable messages, stations that are part of a bus system can request each other to change between different states, and particularly a sleep or quiescent mode and a normal mode. Such systems, which are for example subject to the CAN (controlled area network) protocol or the LIN (local interconnect network) protocol, are typically used in motor vehicles, in which there is a need for electrical energy to be saved. Even when the vehicle is parked, individual stations have to be woken up at regular intervals to perform individual functions. As well as it being possible for a change to be made between the sleep mode and the normal mode, it is also desirable for this change to be able to be made selectively, i.e. for individual stations to be able to be actuated separately.

Known from U.S. Pat. No. 5,581,556 is a local area network in which each bus node has an edge-detection circuit that, when the station is in the sleep mode, wakes a communication control circuit when a signal is detected on the bus line. The communication circuit is able to interpret a selective wake-up signal and wake the station that is connected.

U.S. Pat. No. 6,519,720 discloses a bus system having a plurality of stations in which each individual station may be in three different states. On a first wake-up signal being received, all the stations are switched to a standby state. In the said standby state, current consumption is higher than it is in the quiescent (sleep) state, but lower than in the normal operating state. In the standby state, each station is able to interpret a second wake-up signal on the bus system and to determine whether the station is to be set to the normal operating state or back to the quiescent state.

In US 2003/0208700 is described a bus system in which in which individual stations are actuated by a suitable choice of signal levels and wake-up levels. The wake-up level corresponds to a voltage that is higher than that of the normal signal level, as a result of which the two types of signal are clearly distinguishable. The wake-up signal wakes the entire system, and initially all the stations change from the sleep mode to the normal mode. After that, individual stations can be selected, and the stations that are not affected change back to the sleep mode. It is a disadvantage in this case that, because of the special voltage mentioned, the bus system is no longer compatible with existing bus systems.

There is a trend for functionalities in the CAN application layer, which are normally implemented in software, to be mapped by improving the CAN hardware. The intention in so doing is to relieve the load on the CPU of the microcontroller. WO 01/20434 describes a method of reducing current consumption in a CAN microcontroller in which a large part of the processor is set to a sleep mode and incoming CAN messages are analyzed by suitable hardware, and if an appropriate wake-up message is identified the processor is woken up.

A disadvantage of the prior art described above is the fact that, for individual stations to be selectively woken, wake-up message have to be decoded, for which purpose the part of the bus node that is on standby at the relevant point in time has to have an accurate timer mechanism. It would be particularly desirable if, when a station was in the sleep mode, the transceiver could independently receive and analyze data transmitted on the bus line, particularly to enable it to decide whether its own bus node has to be woken up. In past years there has been a steady rise in the range of functions performed by such transceivers. Many functions for microcontroller-based systems are brought together in the system base chips produced today. As well as having the transceiver itself which acts as a communications interface between the station and the bus line, the chips also assume responsibility for power management of the given bus node and for protective and diagnostic functions for it. However, even the system base chips produced at present are not yet capable of directly analyzing the data that comes from the bus. In particular, a system base chip is not capable of interpreting selective wake-up messages.

It is an object of the invention to specify a method that enables a transceiver or system base chip to independently receive and analyze the data transmitted on the bus line. In particular, the method is intended to make it possible for a bus node or a sub-network to be woken individually by means of a given wake-up message. The intention is for this to be possible even when that part of the bus node that is on standby at the relevant point in time does not have an accurate timer and also does not have any knowledge of the bitrate at which the data is transmitted on the bus.

In accordance with the invention, this object is achieved by means of a bus system having the features specified in claim 1 or by means of a method having the features specified in claim 4. By virtue of the fact that at least one transceiver comprises means for the non-bitrate-dependent analysis of digital signals, it is advantageously possible for digital signals on the bus system to be analyzed even when the exact bitrate is not known. This is advantageous above all when the network node is in the sleep state.

In a preferred embodiment of the invention, provision is made for the means for the non-bitrate-dependent analysis of digital signals to comprise an arrangement for measuring and/or comparing the lengths of successive recessive and dominant phases. What is achieved in this way is that the transceiver is able to analyze simple signals that are encoded by a method having the features specified in claim 4.

In particular, it is preferable for the means for the non-bitrate-dependent analysis of digitals signals to comprise a shift register, a register that contains a pre-stored bit sequence, and means for comparing the bit values stored in the shift register and the other register. In this way, it becomes possible for wake-up messages transmitted over the bus line to be compared with a pre-stored bit sequence and, if the two bit patterns are the same, either for the network node to be woken up or, if required, for the same mechanism to be applied to a confirming message.

A method having the features specified in claim 4 is suitable for encoding the messages that are to be received by the transceiver. Because the value of a bit in that part of the message that is encoded in a non-bitrate-dependent manner is represented by the lengths of successive dominant and recessive phases, a transceiver having the above technical features is able to decode simple messages. In particular, it is able to compare signals encoded by this method with a pre-stored bit sequence and, if the two are the same, to wake up the bus node that is in the sleep state.

The encoding is typically implemented by causing a dominant or “1” (recessive or “0”) bit, in the part that is encoded in a non-bitrate-dependent manner, to be represented by the fact that the length of the dominant phase is longer (shorter) that that of the succeeding recessive phase.

Other preferred embodiments are produced by the other features that are specified in the dependent claims.

These and other aspects of the invention are apparent from and will be elucidated with reference to the embodiments described hereinafter.

In the drawings:

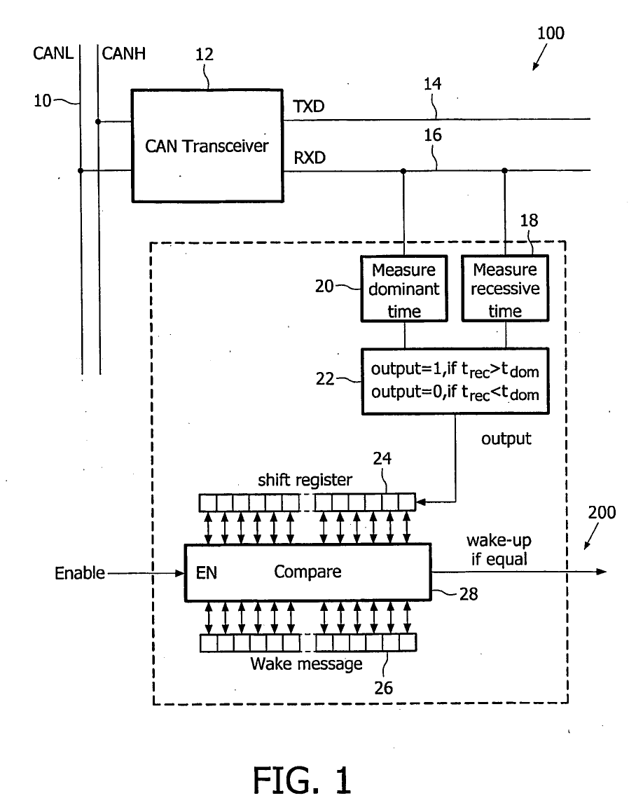

FIG. 1 is a block circuit diagram of a receiver circuit that operates as a selective waking means for the system base chip, and

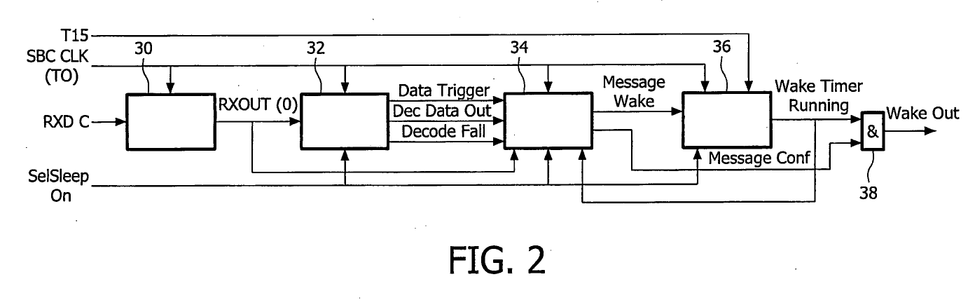

FIG. 2 shows the layout of a receiver employing wake-up and confirming messages.

FIG. 1 shows a transceiver/system base chip that is designated as a whole by reference numeral 100 and that comprises a receiver circuit for the selective waking of the bus node. A CAN transceiver 12 is connected to a CAN bus line 10 having CANL and CANH wires. The rest of the bus node, which is designated as a whole by reference numeral 200, and which is also referred to as the control unit of the system chip, is connected to the CAN transceiver 12 by a data transmission line 14 and a data reception line 16. Connected to the data reception line 16 are electronic circuits 18 and 20, for measuring the length of the recessive phase (1 phase) and dominant phase (0 phase) respectively. These two electronic circuits are called into action alternately. To measure the lengths of the relevant phases, capacitors could for example be charged via a resistor. Connected to the two electronic circuits 18 and 20 is an electronic circuit 22 for comparing the lengths of successive dominant and recessive phases. If the electronic circuits 18 and 20 are implemented by means of capacitors, the electronic circuit 22 could compare the charges in the two capacitors. The electronic circuit 22 emits a recessive/dominant signal when the length of the recessive phase is longer/shorter than the length of the dominant phase. The result is written to a shift register 24. Stored in a register 26 is a wake-up message. An electronic circuit 28 continuously compares the individual bit values that are present in the shift register 24 and in the register 26 containing the stored wake-up message. If all the bit values are the same, the wake-up message is detected and the control unit 200 is activated.

With the arrangement shown in FIG. 1 it is now easy for an individual station on a bus system to be woken selectively. For this purpose the transmitter, which may for example be another station connected to the bus system, has to encode the transmitted data by following a particular scheme. What is crucial in the encoding is the ratio of the durations of alternating recessive and dominant phases on the bus line. To transmit a 0, bit sequences of the following form may be emitted:

(1)001(0)

(1)0001(0)

(1)00011(0), etc.

Similarly, a 1 to be transmitted is encoded as follows:

(1)011(0)

(1)0111(0)

(1)00111(0), etc.

Considerably longer sequences are also possible and what is crucial is merely the ratio between successive dominant and recessive phases. The arrangement show in FIG. 1 relates to a CAN bus system. The method discussed here and the associated arrangement may however equally well be used in a LIN (local interconnect network). The LIN specification was developed in this case as a simple multiplex solution that supplements the CAN protocol and at the same time reduces the costs of development, production and maintenance. Also, what was taken as a basis in the description of FIG. 1 was a wake-up message. The message transmitted to the system base chip 100 could however equally well contain configuring data or other commands. The messages to be transmitted are typically written to a data block in the given communications protocol. If the message to be transmitted exceeds the available length of the data block, the message is divided into a plurality of part-messages that are transmitted in a plurality of data blocks. If the message involved is a wake-up message and if the electronic circuit 28 has received the first part-message successfully, the pattern of the second part-message is placed in store in the register 26. A timer that is not shown in FIG. 1 is started. The second part-message of the wake-up signal has to be detected within a defined time-span. Alternatively, the arrangement may be constructed in such a way that all the individual part-messages have to be transmitted within a given length of time. Division of the wake-up signal into part-messages is also desirable because in general there are a large number of CAN messages traveling along the bus, depending on the number of stations that are connected to the bus system and the workload that the different stations have. The likelihood of a sequence of dominant and recessive phases that is identical to a wake-up message occurring by chance in this case can be reduced as desired by having the first message confirmed by a plurality of messages, which ideally are different from one another.

FIG. 2 illustrates this mechanism by reference to an embodiment in which a search is made for an initial wake-up message and a confirming message. The digital signals coming from the bus system pass through a noise filter 30 to a decoder 32. The decoder 32 corresponds to the electronic circuits 18, 20 and 22 in FIG. 1. The decoded data is passed on to a scanner 34 that corresponds to the registers 24 and 26 and the electronic comparator circuit 28 in FIG. 1. The scanner searches for pre-programmed messages. When the initial wake-up message is received, a timer 36 is started. If the second, confirming message is received within a given window of time, two positive results are passed on to an AND circuit 38 and the remaining part of the control unit 200 is woken up.

Errors may occur in the decoder 32 as a result of the fact that the dominant and recessive phases measured are equal or that one of the phases exceeds a given measure of time. In this event, what is termed a DecodeFail signal can be transmitted to the scanner, which then ignores the data so far received. The scanner 34 may comprise a shift register, or a state machine that is able to recognize one or more bit sequences.

### LIST OF REFERENCE NUMERALS

100 System base chip/transceiver
200 Control unit/microcontroller
10 CAN bus line having CANL and CANH lines
12 CAN transceiver
14 Data transmission line
16 Data reception line
18 Electronic circuit for measuring the length of the recessive phase
20 Electronic circuit for measuring the length of the dominant phase
22 Electronic circuit for comparing the lengths of successive dominant and recessive phases
24 Shift register
26 Register containing stored wake-up message
28 Electronic circuit for comparing individual bit values
30 Noise filter
32 Decoder
34 Scanner
36 Timer
38 AND circuit

1. A bus system having a plurality of stations that are coupled together by means of an arrangement of lines and each have a transceiver and a control unit, a microcontroller, or the like, characterized in that at least one transceiver comprises means for the non-bitrate-dependent analysis of digital signals.

2. A bus system as claimed in claim 1, characterized in that the means for the non-bitrate-dependent analysis of digital signals comprise an arrangement for measuring and/or comparing the lengths of successive recessive and dominant phases.

3. A bus system as claimed in claim 1, characterized in that the means for the non-bitrate-dependent analysis of digital signals comprise a shift register a register that contains a pre-stored bit sequence, and means for comparing the bit values that are stored in the shift register and in the other register.

4. A method of encoding a digital message on a bus system in which the digital message comprises at least one part that is encoded in a non-bitrate-dependent manner, characterized in that the value of a bit in that part of the message that is encoded in a non-bitrate-dependent manner is represented by the lengths of successive dominant and recessive phases.

5. A method as claimed in claim 4, characterized in that, in the part that is encoded in a non-bitrate-dependent manner, a dominant (recessive) bit is represented by the fact that the length of the dominant phase is longer (shorter) than that of the succeeding recessive phase.

6. A method as claimed in claim 4, characterized in that the digital message is a CAN or LIN message.

7. A method as claimed in claim 6, characterized in that the part of the message that is encoded in a non-bitrate-dependent manner is contained in the data block of the CAN message, Flex-Ray message or LIN message.

8. A method as claimed in claim 4, characterized in that the part of the message that is encoded in a non-bitrate-dependent manner comprises a wake-up message or configuring data.

9. A method as claimed in claim 4, characterized in that those parts of different messages that are encoded in a non-bitrate-dependent manner represent a wake-up message, or a wake-up message and at least one confirming message, in which case the confirming message must arrive within a defined time.

10. A transceiver, particularly for use on a bus system, characterized in that the transceiver comprises means for the non-bitrate-dependent analysis of digital signals.
